(19) United States
(12) Patent Application Publication
(10) Pub. No.: US 2009/0147517 A1
(43) Pub. Date: Jun. 11, 2009

(54) LED RECESSED LAMP WITH SCREWS FIXING A RECESSED FIXTURE THEREOF

(75) Inventors: HAO LI, Shenzhen (CN); YONG-DONG CHEN, Shenzhen (CN); SHIH-HSUN WUNG, Tu-Cheng (TW)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/024,959

(22) Filed: Feb. 1, 2008

(30) Foreign Application Priority Data
Dec. 7, 2007 (CN) 200710124918.7

(51) Int. Cl. F21S 4/00; F21V 21/00; F21V 29/00

(52) U.S. Cl. 362/249.02; 362/365; 362/373

(57) ABSTRACT

An LED recessed lamp for being received in a wall, including a housing (10), a plurality of LEDs (20) embedded into the housing, a heat sink (30) secured below the housing, a casing (40) enclosing the housing, and a pair of arms (50) resiliently and pivotably attached on the casing. The casing is fixed to the housing by using a screwdriver to screw screws (60) through the casing and into the housing, which provides a convenient assembling of the LED recessed lamp. The screwed connection between the housing and the casing enables a user to easily disassemble the housing from the casing if a flawed component is needed to be replaced or mended.

### BACKGROUND OF THE INVENTION

1. Field of the Invention

The present invention relates to a light emitting diode (LED) recessed lamp, and more particularly to an LED recessed lamp incorporating screws for assembling the LED recessed lamp conveniently.

2. Description of related art

With respect to conventional light source, LED has many advantages, e.g., higher light intensity, longer lifetime, lighter weight, smaller geometry, which promote the LED to be used for substituting the conventional light source in various fields, such as residential, commercial, industrial, and institutional settings.

Typically, an LED recessed lamp is utilized to provide light in a decorative manner. The LED recessed lamp may comprise an outer case for being retained in a wall, a pair of arms clamping the wall for fixing the LED recessed lamp therein, an inner case received in the outer case, and a plurality of LEDs mounted in the inner case. When the LEDs are activated, the LED recessed lamp produces a light beam out of the wall, to thereby illuminate the ambient.

However, the inner case of the conventional LED recessed lamp is often fixed in the outer case by rivets. When in assembly, it is inconvenient to put tools into the inner case to press against inner ends of the rivets outwardly, in order to make them expand and abut against the inner case. In addition, when a flaw is found, it is very difficult to dissemble the LED recessed lamp to mend the flaw once the outer and inner cases are riveted together.

What is needed, therefore, is an LED recessed lamp which can overcome the above-mentioned disadvantages.

### SUMMARY OF THE INVENTION

An LED recessed lamp for being received into a wall, including a housing, a plurality of LEDs embedded into the housing, a heat sink secured below the housing, a casing enclosing the housing, and a pair of arms resiliently and pivotably attached on the casing. The casing is fixed to the housing by using a screwdriver to screw screws through the casing and into the housing.

Other advantages and novel features of the present invention will become more apparent from the following detailed description when taken in conjunction with the accompanying drawings, in which:

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of an LED recessed lamp in accordance with a preferred embodiment of the present invention;

FIG. 2 is an exploded view of FIG. 1; and

FIG. 3 is an inverted view of FIG. 1.

### DETAILED DESCRIPTION OF THE INVENTION

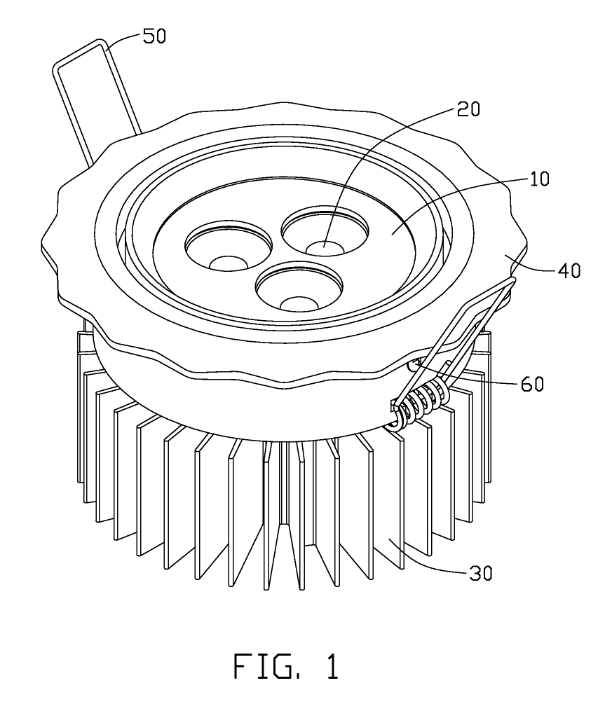

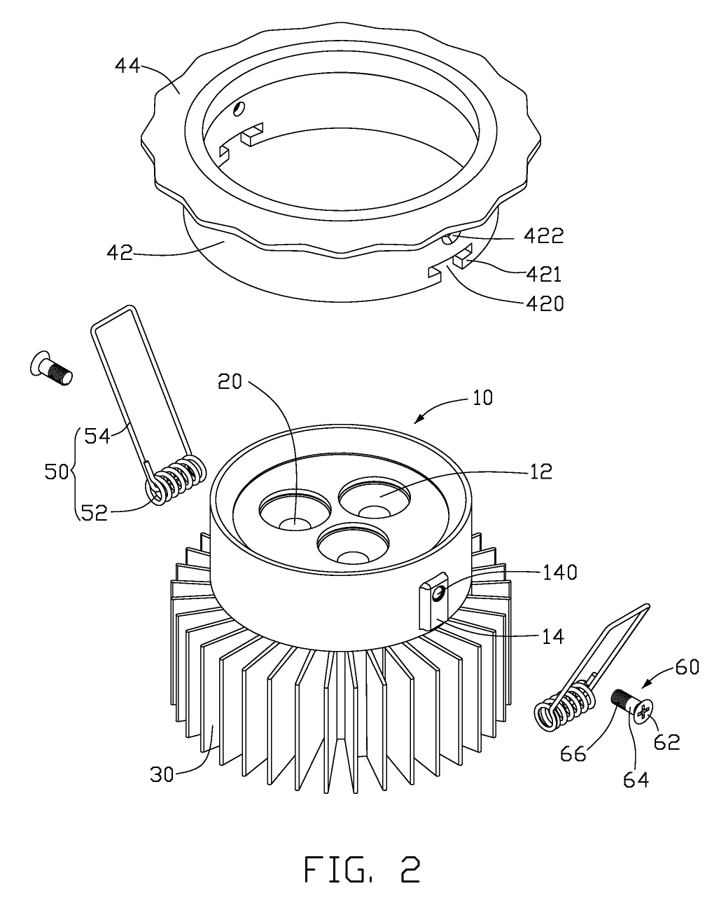

Referring to FIGS. 1 and 2, an LED recessed lamp in accordance with a preferred embodiment of the present invention comprises a housing 10, a plurality of LEDs 20 positioned in the housing 10, a heat sink 30 attached below the housing 10, a casing 40 sleeved on the housing 10, a pair of arms 50 resiliently and pivotably fixed on the casing 40, and a pair of screws 60 extending through the housing 10 and threaded in the casing 40, to thereby secure the casing 40 to the housing 10. Each of the pair of screws 60 comprises a head 62, a smooth portion 64 extending from the head 62, and a threaded portion 66 connecting with and extending from the smooth portion 64.

The housing 10 has a cylindrical shape with a top face concaved downwardly to form a tapered void (not labeled) therein, which has a diameter decreasing downwardly. Three cavities 12 are defined in an evenly distributed manner at a bottom face of the void, with the plurality of LEDs 20 embedded thereinto, respectively, whereby when the plurality of LEDs 20 are activated, a part of light emitted from the plurality of LEDs 20 is able to transfer to an outside directly, and remaining part of the light would be reflected by inner faces of the three cavities 12, and then combine with the part of the light to radiate to the outside. A pair of ears 14 are devised in an opposing relationship at an outer periphery of the housing 10, wherein each of the pair of ears 14 has a rectangular configuration, with a top thereof lower than the top face of the housing 10, and a bottom thereof slightly higher than a bottom face of the housing 10. A transverse threaded hole 140 is defined through the threaded portion 66 of a corresponding one of the pair of screws 60 therein.

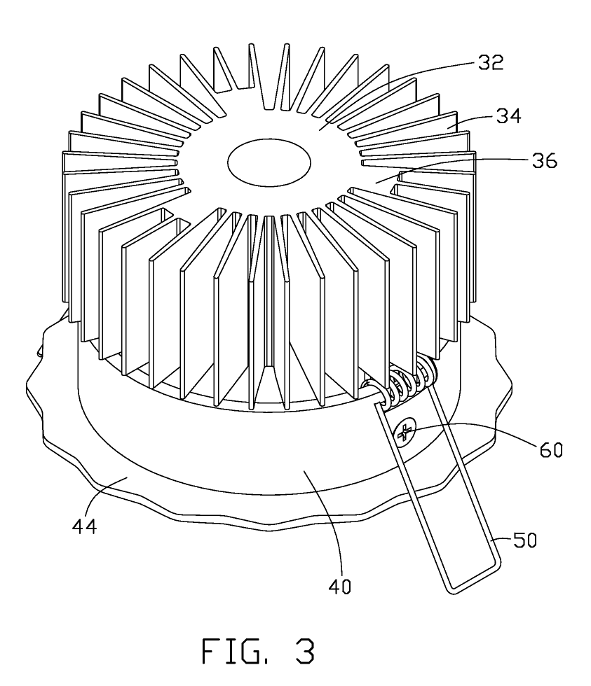

Also referring to FIG. 3, the heat sink 30 is designed at a bottom of the housing 10 and has an exterior diameter larger than that of the housing 10. The heat sink 30 consists of a tubular body 32 extending downwardly from the bottom face of the housing 10, and a plurality of fins 34 extending outwardly and radially from an outer circumference of the tubular body 32. The tubular body 32 is coaxial with the housing 10, and has a hole (not labeled) defined in a central area thereof, for allowing an airflow therethrough. Three junctions 36 are formed equidistantly around the outer circumference of the tubular body 32, for reinforcing the heat sink 30. Each of the three junctions 36 couples with three of the plurality of fins 34, with two lateral ones of the three of the plurality of fins 34 being symmetrical with respective to a middle one of the three of the plurality of fins 34.

Referring back to FIG. 2, the casing 40 is disposed around the housing 10 and it comprises an annular sidewall 42 and a flange 44 extending outwardly and vertically from the sidewall 42. The sidewall 42 has a diameter larger than that of the housing 10, and similar to a distance between outer surfaces of the pair of ears 14. A pair of recesses 420 are defined in a bottom of the sidewall 42, located corresponding to the pair of ears 14. Each of the pair of recesses 420 has a T shape so that the bottom of the sidewall 42 forms a pair of opposing ribs 421 beside a corresponding recess 420. The ribs 421 are used to retain a corresponding arm 50 to the sidewall 42 of the casing 40. The sidewall 42 further defines a pair of holes 422 just above the pair of recesses 420, respectively, for receiving the smooth portions 64 of the pair of screws 60 thereinto; thus, as the casing 40 assembled on the housing 10, an inner periphery of the sidewall 42 abuts interferingly against with the outer surfaces of the pair of ears 14, and the pair of holes 422 are in line with the threaded holes 140 of the housing 10. The flange 44 is located at a top of the sidewall 42 for abutting against a front side of a wall panel or ceiling (not shown), where the LED recessed lamp is received. The flange 44 has a waved periphery for achieving a decorative effect.

Each of the arms 50 comprises a spiral portion 52 retained in a corresponding recess 420 by inserting the ribs 421 into the spiral portion 52, and a rectangular portion 54 inclinedly fixed on the spiral portion 52 for resiliently abutting against a rear side of the wall panel or ceiling, thus firmly fixing the LED recessed lamp therein.

When assembling the LED recessed lamp, what a user or operator needs to do is only to dispose the casing 40 around the housing 10 with the pair of holes 422 of the casing 40 being in line with the threaded holes 140 of the housing 10, and then use a screwdriver (not shown) to fasten the screws 60 through the pair of holes 422 of the casing 40 and into the threaded holes 140 of the housing 10, respectively, whereby the casing 40 is firmly attached to the housing 10. It is much convenient and easy to use the screwdriver and the screws 60 to assemble the casing 40 and the housing 10 together, than use a riveting tool (not shown) and rivets (not shown). Furthermore, when it is necessary to replace a flawed component, the casing 40 can be detached easily from the housing 10 by unscrewing the screws 60 away from the housing 10.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An LED recessed lamp comprising:
a housing adapted for being retained in a wall, the housing forming a pair of opposing ears at an outer periphery thereof;
a plurality of LEDs received in the housing;
a casing enclosing the housing and adapted for abutting against the wall;
a pair of screws extending through the casing and threadedly engaging in the pair of opposing ears of the housing;
a heat sink fixed below the housing and for being accommodated in the wall, comprising:
a tubular body; and
a plurality of fins extending outwardly from the tubular body.

2. The LED recessed lamp as claimed in claim 1, wherein the housing has a top face concaved downwardly to form a tapered void, and a plurality of cavities defined at a bottom face of the tapered void, the plurality of LEDs being embedded into the plurality of cavities, respectively.

3. The LED recessed lamp as claimed in claim 1, wherein a threaded end of each of the pair of screws being threadedly engaged in a corresponding one of the pair of opposing ears.

4. The LED recessed lamp as claimed in claim 3, wherein the casing comprises a sidewall and a flange extending outwardly and perpendicularly from a top of the sidewall, the flange being adapted for abutting a front side of the wall.

5. The LED recessed lamp as claimed in claim 4, wherein an inner periphery of the sidewall of the casing abuts interferingly against outer surfaces of the pair of opposing ears of the housing, a smooth portion of the each of the pair of screws being inserted into the sidewall of the casing.

6. The LED recessed lamp as claimed in claim 4, wherein the sidewall of the casing defines a pair of T-shaped recesses at a bottom thereof and located corresponding to the pair of opposing ears of the housing.

7. The LED recessed lamp as claimed in claim 6 further comprising a pair of arms, wherein each of the pair of arms comprises a spiral portion retained in each of the pair of T-shaped recesses of the casing, and a rectangular portion adapted for abutting against a rear side of the wall.

8. The LED recessed lamp as claimed in claim 1, wherein the tubular body of the heat sink has three junctions equidistantly formed around an outer periphery thereof, each of the three junctions coupling with three ones of the plurality of fins.

9. The LED recessed lamp as claimed in claim 1, wherein the pair of screws are oriented perpendicular to an axis of the housing.

10. A recessed lamp fixture comprising:
a housing adapted for receiving a plurality of light sources therein, comprising a pair of ears formed oppositely from an outer periphery thereof;
a casing comprising an annular sidewall abutting interferingly against the pair of ears and surrounding the housing; and
a pair of screws extending perpendicularly through the annular sidewall of the casing and engaging in the pair of ears, respectively.

11. The recessed lamp fixture as claimed in claim 10, wherein each of the pair of screws comprises a head, a smooth portion extending from the head, and a threaded portion connecting the smooth portion, the smooth portion being located into the annular sidewall of the casing, and the threaded portion being screwed into a corresponding one of the pair of ears of the housing.

12. The recessed lamp fixture as claimed in claim 10 further comprising a heat sink formed beneath the housing, wherein the heat sink has an outer diameter larger than that of the housing.

13. The recessed lamp fixture as claimed in claim 12, wherein the heat sink comprises a hollow post, a plurality of fins extending radially from the hollow post, and a plurality of joints each coupling with three ones of the plurality of fins.

14. The recessed lamp fixture as claimed in claim 10, wherein the casing comprises a flange extending outwardly and vertically from a top of the annular sidewall, the flange having a waved periphery.

15. The recessed lamp fixture as claimed in claim 14 further comprising a pair of arms resiliently and pivotably engaging with the annular sidewall of the casing, wherein the pair of arms and the flange of the casing are adapted for cooperatively sandwiching a wall therebetween to fix the LED recessed lamp fixture to the wall.

16. The recessed lamp fixture as claimed in claim 15, wherein each of the arms comprises a spiral portion locked with the annular sidewall of the casing, and a rectangular portion slantwise secured to the spiral portion.
